(19) United States
(12) Patent Application Publication
(10) Pub. No.: US 2024/0025624 A1
(43) Pub. Date: Jan. 25, 2024

(54) EXPANDABLE POLYLACTIC ACID-BASED THERMAL PACKAGING AND METHODS THEREOF

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/476,894

(22) Filed: Sep. 28, 2023

Related U.S. Application Data
(63) Continuation-in-part of application No. 18/356,617, filed on Jul. 21, 2023.
(60) Provisional application No. 63/369,005, filed on Jul. 21, 2022.
(60) Provisional application No. 63/482,136, filed on Jan. 30, 2023.
(60) Provisional application No. 63/476,041, filed on Dec. 19, 2022.

(51) Int. Cl. B65D 81/38; B65D 65/46; B65D 43/02; B65B 25/00; B65B 57/00; B65B 59/00; B26D 7/27

(52) U.S. Cl. CPC B65D 81/3827; B65D 65/466; B65D 81/383; B65D 43/0235; B65B 25/00; B65B 57/00; B65B 59/001; B26D 7/27

(57) ABSTRACT

Molded foam articles in the form of containers are provided. The containers have at least two portions formed from polylactic acid-based molded bead foam and joined together using a heat-seal. The at least two portions are tailor-made to have a specific size and shape suitable for thermally sensitive commodities and may be customized based on the intended destination for the commodities and potential changes in weather in route. The containers may include one or more stand-offs for providing additional thermal energy protection, further enhancing the customizability of the containers. The containers may be formed from a single, flat foam panel that is cut and formed into a container on site, dramatically increasing the versatility of the container and reducing the carbon footprint associated with the container.

### CROSS-REFERENCE TO RELATED APPLICATIONS

This application is a continuation-in-part of U.S. patent application Ser. No. 18/356,617, filed Jul. 21, 2023, which claims priority to U.S. Provisional Patent Application No. 63/369,005, filed Jul. 21, 2022, and U.S. Provisional Patent Application No. 63/482,136, filed Jan. 30, 2023, each of which are incorporated herein by reference. This application also claims priority to U.S. Provisional Patent Application No. 63/476,041, filed Dec. 19, 2022, which is incorporated herein by reference.

### FIELD OF THE DISCLOSURE

This disclosure relates generally to molded foam articles and, in particular, relates to tailor-made molded foam articles formed entirely from a single material having stand-offs for forming air pockets for improved thermal capabilities.

### BACKGROUND

Molded foam articles are used in a variety of diverse industries including thermal insulation and protective packaging, construction, infrastructure support, foodservice, and consumer products such as surfboards. Molded foam articles are commonly produced from expandable polystyrene (EPS), which has a well-known manufacturing process. However, EPS-based foam articles suffer from a variety of drawbacks that require compensating the properties of the EPS-based foam articles so that they may successfully be used for their desired purpose.

Consumer-facing foam articles such as insulated shippers are commonly used for shipping meal kits, confectionary products, cakes, other perishable goods, and pharmaceutical items such as vaccines. The overall retail market in the United States was around $4.3 trillion in 2021, with ecommerce accounting for around $1 trillion. In 2022, sales from Amazon alone exceeded in-store sales from Wal-Mart, with over 11.5% of Wal-Mart's own sales occurring online. The vast majority of product packaging used to pack and ship fragile or perishable products purchased online are EPS-based insulated shippers typically enclosed in a corrugated cardboard box because direct application of tapes and other adhesives on the EPS-based shipper lose efficacy after a short period of time. Alternatively, some insulated EPS shippers are held together with straps or a shrink sleeve. However, both of these methods involve using a different material to keep the shipper lid secured to the base.

Shipping pharmaceuticals presents still further challenges because a particular temperature window must be maintained during the entire shipment duration beginning from the pharma manufacturer or distributor to homes, clinics, and hospitals. The thermal shipment package must be engineered for the intended payload and include sufficient phase change material (e.g., ice packs) to not only complete the journey but also account for variability in weather conditions, travel time variability such as delays, and ingress/egress of thermal energy. Typical solutions to accounting for this variability add considerable weight and size to the thermal shippers resulting in higher shipping costs and associated carbon emissions. This variability is typically built-in to the shippers so that a distributor may produce a small number of different sized shippers for the entire year's use for a given payload, resulting in dramatic overcompensation for a majority of shipments. In other words, the shipper for a particular payload is designed for the most extreme variability in shipment such that the shipper is “overkill” most of the time.

Alternatives to EPS-based shippers have taken the form of molded pulp packaging which, although recyclable on their own, still require additional components such as an outer corrugate layer, tape, or labels. Another alternative is thermoformed polyethylene terephthalate (PET), which again requires an additional component such as corrugate if used to ship impact-sensitive commodities. Another alternative uses inflatable air protectors using polyethylene film, but these inflatable protectors must be enclosed in corrugate to protect the integrity of the inflated protectors. Yet another alternative shipper takes the form of a wooden crate with packaging such as straw or paper strips, most commonly seen for shipping wine bottles. One attempt to homogenize the materials in a shipper takes the form of a corrugate-only shipper, but this solution sacrifices the thermal and impact protection characteristic of expandable foam packaging. Recycling each of these shippers requires additional effort and cost associated with separating the disparate components.

Previous attempts to mitigate the additional costs and drawbacks associated with material mismatch involve corrugated cardboard with paper-based tape and labels. However, the cost associated with tape, glue, varnish, and heavy printing on the corrugate result in increased levels of solid waste, wasted energy, and chemical use to clean corrugate for reuse. Furthermore, corrugated cardboard alone offers poor impact and vibration protection that must be compensated for through the addition of more corrugate, increasing packaging size and weight.

Accordingly, improved molded foam articles are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a side view in cross-section of a container in accordance with the present disclosure.

FIG. 2 is a perspective view of a container having stand-offs in accordance with the present disclosure.

FIG. 3 is a container having stand-offs and an additional foam panel in accordance with the present disclosure.

FIG. 4 depicts a container-within-container in accordance with the present disclosure.

FIGS. 5A-5D depict steps in a method of making a container in accordance with the present disclosure.

FIG. 6 depicts multiple sized containers in accordance with the present disclosure.

FIGS. 7A-7B depict a plug-style lid in accordance with the present disclosure.

FIGS. 8A-8D depict a thermal shipper with stand-offs, phase change material, and a payload in accordance with the present disclosure.

### DETAILED DESCRIPTION

Containers such as thermal shippers are provided herein including molded foam articles formed from a single material, i.e., mono-material molded foam articles, which enables the formation highly customized shippers that can be produced in seconds, and may include additional molded foam stand-offs for forming an additional thermal barrier. In particular, it has been unexpectedly discovered that forming a container from a plurality of portions, each portion comprising a molded foam article consisting of polylactic acid-based molded bead foam, enables the formation of a container that takes advantage of self-adhesion properties of polylactic acid, thereby enabling the formation of containers with variable wall thickness, variable size, etc. Furthermore, it has been unexpectedly discovered that one or more additional pieces of polylactic acid-based molded bead foam can be attached to the interior of the container to create a “pocket” of air, providing an additional barrier to thermal energy transfer.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

Containers

Containers are disclosed herein. In some embodiments, the containers include two or more portions configured to be joined together using a heat-seal without the use of adhesive to form the container, each portion consisting of polylactic acid (PLA) molded bead foam. As used herein, a “molded bead foam portion” refers to an article formed from a polymeric foam that has gone through an expansion and bead molding process. The article may be in the form of a two-dimensional panel or a three-dimensional structure such as a box. For example, a molded bead foam 5-sided box may be formed as a single, monolithic article, which may be joined to a molded bead foam panel in the form of a lid to the 5-sided box. In this way, two portions (the box and the lid) form the container. As another example, six separate foam panels, which may or may not be identical depending on the desired dimensions of the container, may be joined to one another to form a box. In this way, six portions (the six panels) form the container.

As used herein, a “container” refers to any enclosure into which a consumer product may be placed for storage, shipping, and/or presentation to the consumer. For example, the container may be a thermal shipper for shipping thermally sensitive goods. Although the container is depicted in the Figures as a 6-sided box, the container may take the form of another shape, such as a sphere, triangular prism, or another shape depending on the needs of the application and the particular product presentation desired by the manufacturer of the goods.

In some embodiments, the plurality of portions that form the container are joined together using a heat-seal. In other words, at least two adjacent surfaces, one corresponding to a first portion and another corresponding to a second portion, are heated and pressed together such that the interface between the surfaces is sealed. In some embodiments, the heat-sealed interface operates as a tamper-evident seal. In some embodiments, the force necessary to remove the heat sealed interface, i.e., the force necessary to break the tamper-evident seal, can be adjusted by adjusting the cross-sectional area of adhesion and the force used to adhere the two portions. In some embodiments, the force required for separating the heat-sealed portions may be from about 5 lbf to about 50 lbf. In some embodiments, the force necessary to separate the heat-sealed portions is approximately equal to the force required to break or fracture one of the molded foam articles. It has been unexpectedly discovered that the heat-sealed interface may have an adhesion strength equal to a monolithic molded foam article. For example, the heat-sealed interface may require between about 5 to about 10 lbf to separate, representing a tamper-evident seal that can be removed by a consumer through application of reasonable manual force. As another example, the heat-sealed interface may require between about 40 to about 50 lbf to separate, which may require tools such as a knife to separate.

It has been further unexpectedly discovered that a heat-sealed interface has a high resistance to thermal energy transfer that is comparable to a monolithic molded foam article. Conventional thermal shippers such as the ones commonly used to ship therapeutic products are most susceptible to thermal energy transfer at the interface between molded foam articles, such as the lid-base interface. By forming the container from polylactic acid, as described herein, the various portions that are combined to form the container can be secured together using a heat seal that experiences a similar amount of thermal energy transfer as the walls of the container itself, enabling substantial thermal energy resistance. For example, an open box may be formed from polylactic acid-based molded bead foam, loaded with phase change material and a payload, and a lid may be secured to the box by heating the surface of the lid that is intended to come into contact with the box, thereby sealing the lid to the box and maximizing thermal protection. This subsequently enables smaller and lighter thermal shippers; the walls of the container can be thinner and less phase change material is necessary to preserve the temperature of goods inside the container.

By forming the container from portions that are heat-sealed together as described herein, it becomes possible to construct the container around the payload, which may simplify the loading process. For example, a payload having a low clearance between side walls (i.e., a “tighter” fit) may be positioned on top of a first portion, and subsequent portions may be heat-sealed to the first portion around the payload. This is particularly advantageous when human labor is used to load containers; payload can be inserted into the container from the side, rather than from the top, and the “missing side” may be added after loading. This may reduce injuries relating to carrying heavy objects and lowering them into a container opened from only the top.

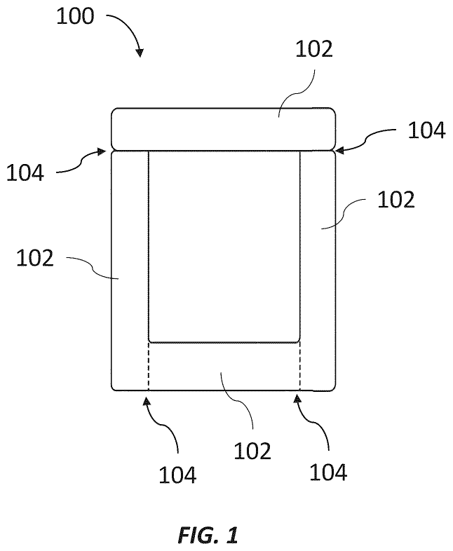

FIG. 1 depicts an exemplary container 100 formed from portions 102. Portions 102 meet at interfaces 104 that are heat-sealed to form the container.

In some embodiments, the container includes at least one stand-off attached to an inner surface of one of the plurality of portions. As used herein, a “stand-off” refers to a piece of molded foam having a thickness sufficient to create a gap or a space between one of the container walls and the contents of the container, thereby preventing the contents of the container from directly contacting the walls of the container. The stand-offs are configured to create a space filled with air between the contents of the container and the walls of the container; therefore, the stand-offs described herein may have a depth necessary to create a space between the contents of the container and the walls of the container, but a length and width of a sufficient size to maintain structural integrity while covering a minimal amount of container wall surface area. Since air has a lower heat capacity than the container walls themselves, separating the contents of the container from the walls of the container reduces the ΔT across the container wall and reduces the driving force for heat transfer. In some embodiments, the effective thermal energy retention duration may be increased by around 20% by including the stand-offs alone, and the effective thermal energy retention duration may be increased even more by including phase change material in addition to stand-offs.

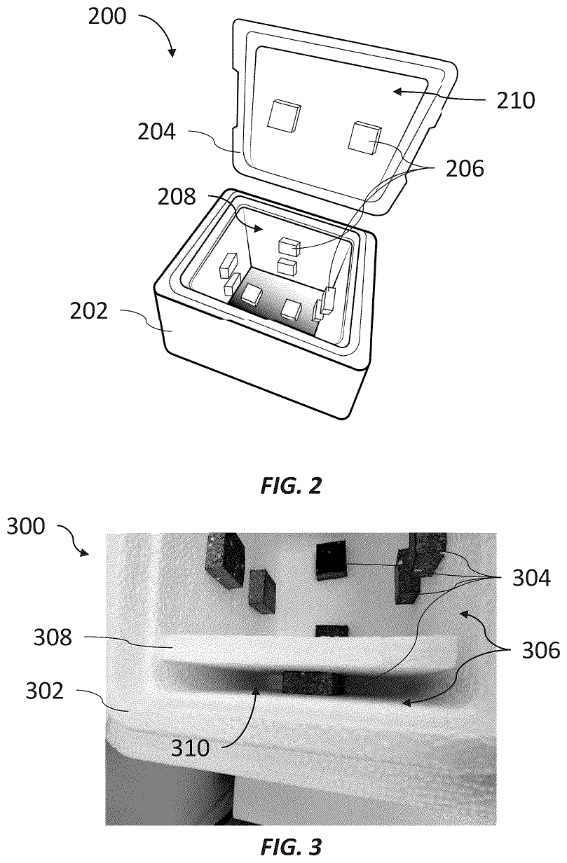

FIG. 2 depicts a container 200 formed from a first portion 202 in the form of a molded box and second portion 204 in the form of a lid configured to seal the first portion 202. Container 200 includes a plurality of stand-offs 206 adhered to the inner surface 208 of the first portion 202 and to the inner surface 210 of the second portion 204.

In some embodiments, the stand-offs described herein are formed on the inner surface of the portion from which it extends through the same molding process that formed the portion itself. In other words, the molded bead foam article produced by the molding process may take the form of one wall intended to be used in a container, and the mold itself is responsible for forming a protrusion for use as a stand-off. In other embodiments, the stand-off is a separate article that is adhered to the inner surface of the portion from which it extends.

In some embodiments, the stand-off may act as a reinforcing member. As described below, the containers of the present disclosure may be formed by joining several separate molded foam walls together through a heat-sealing adhesion process. The stand-off may be strategically positioned within the container so that the stand-off adhered to two molded foam walls simultaneously, providing additional structural support to the interface between two joined walls.

In some embodiments, one or more stand-offs are affixed directly to the payload within the container. Conventional thermal shippers may include “dunnage” that physically isolates the payload from any phase change material within the container. This dunnage creates a physical gap, but not thermal gap, so that particularly cold phase change material does not directly contact the payload and damage the payload. It has been unexpectedly discovered that forming stand-offs from polylactic acid-based molded bead foam enables adhesion of the stand-off to the payload itself through a heat-seal, a phenomenon that is not possible with EPS-based molded foam without additional adhesive. Instead, such stand-offs would need to be adhered to EPS-based molded foam using glue, which bond strength changes with time.

In some embodiments, the container includes one or more additional stand-offs each attached to an inner surface of one of the at least two portions, each of the one or more additional stand-offs consisting of polylactic acid-based molded bead foam. For example, there may be one stand-off in approximately the center of each wall that forms the container so that the contents of the container are separated by every wall by a stand-off. As another example, there may be two or more stand-offs attached to any given surface depending on the size of the contents of the container and the size of the stand-offs.

In some embodiments, the container includes a foam panel formed from polylactic acid-based molded bead foam positioned within the container adjacent to the stand-off so that a gap is formed between the panel and the inner surface of the container. FIG. 3 depicts a container 300 including a portion 302 in the form of a box. Stand-offs 304 are positioned within the container and adhered to the inner surface 306 of the portion 302. Foam panel 308 is positioned within container 300 adjacent to a stand-off 304 so that a gap 310 is formed between the foam panel 308 and the inner surface 306 of the portion 302.

In some embodiments, the container includes at least one stand-off on each inner surface of the container, and the container further includes a secondary container disposed within the container and in contact with each of the stand-offs. By utilizing a secondary container disposed within the volume defined by the innermost edges of each stand-off, a 3-layer regime of thermal energy protection is formed: the outermost container, a gap of air, and the innermost container. Such a configuration may be desired in more extreme cases when the shipper is expected to take a particularly long time, go through a particularly warm/cold climate, and/or be used to ship particularly sensitive commodities. Furthermore, as described herein, forming such a container-within-container can be done simply by cutting various panels to an appropriate size and heat-sealing them together.

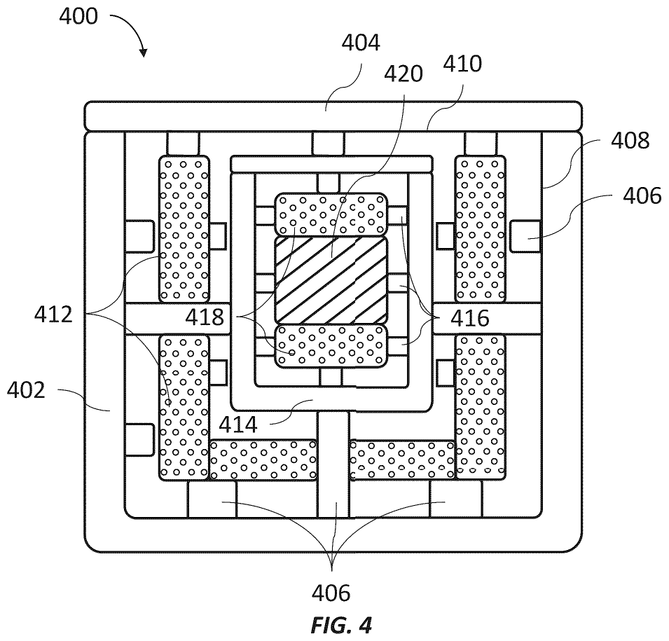

FIG. 4 depicts a container 400 including a first portion 402 and second portion 404. Primary stand-offs 406 are adhered to the inner surface 408 of the first portion 402 and the inner surface 410 of the second portion 404. Phase change material 412 is positioned within the container against the primary stand-offs 406. A secondary container 414 is disposed within the container 400 and includes secondary stand-offs 416, additional phase change material 418, and the payload 420.

In embodiments in which a phase change material is loaded into a container including stand-offs, the phase change material may rest on or against the stand-offs, thereby forming a gap between the phase change material and the inner surface of the container. This gap would instead be occupied by air, which may serve as an additional barrier to thermal energy transfer.

In some embodiments, at least one portion has a thickness of 3 inches or greater. It has been unexpectedly discovered that increasing the thickness of the walls of a thermal shipper from 1.5 inches, which is commonly utilized in thermal shippers, to approximately 4 inches increases the efficacy of the thermal shipper from 40 hours to 144 hours with a minimal increase in the overall weight of the shipper. Shippers formed from EPS cannot be molded to a thickness of 3 inches or greater via conventional bead molding processes, so achieving the same thermal capabilities with an EPS based shipper would require additional phase change material, which is significantly heavier than the increased wall thickness of the PLA-based shipper described herein.

In some embodiments, the at least two portions are initially separate until joined together. For example, the at least two portions may each have a surface with a corresponding shape such that the at least two portions may be joined together by heating the surfaces and pressing them together. In some embodiments, the at least two portions are initially joined at a hinged interface such as a living hinge. For example, the at least two portions may be configured to “open” and “close” along the hinge to permit the insertion and/or removal of product(s) within the container such that the container takes the form of a “clamshell” container.

In some embodiments, the container includes at least one interface between the at least two portions, the interface sealed by a PLA-based film. PLA-based film to seal the edge or using hot film at the interface enables sealing without tape or additional structural components such as corrugated cardboard, shrink-film, or bands/straps. It has been unexpectedly discovered that PLA-based film readily adheres to the surface of PLA-based molded bead foam articles, enabling the formation of a mono-material package. In some embodiments, the PLA-based film operates as a tamper-evident seal for the container. In some embodiments, the PLA-based film is further printed with ink to enhance the ability to detect tampering. It has further been unexpectedly discovered that the adhesion of a PLA-based film to a surface of a PLA-based molded bead foam article can supplement defects in the molding process, such as localized imperfections or poor fusion between beads

In some embodiments, the effective temperature range for facilitating adhesion of the PLA-based film varies depending on the film thickness, crystallinity, draw, sticky point, and conductivity. Some PLA-based films experience adhesion best at one range of temperatures, such as between about 250° F. and 360° F., although the suitable ranges for temperatures vary with the dimensions of the PLA-based film and the PLA-based molded foam article. Depending on the properties of the PLA-based film, the molding process and film adhesion process may have a coincident optimal temperature range, such as between about 300° F. and 330° F., so that the molded bead foam article may be formed and simultaneously, or at least immediately subsequently, be adhered to or with a PLA-based film. As used herein, a “PLA-based film” refers to a film including PLA polymer blended with other degradable polymers such as PBS, PBAT, or PHA.

In some embodiments, when a surface of the molded bead foam article is heated by a heating element, the molded bead foam article is capable of adhering to a second molded bead foam article without the need for adhesives and without producing flammable gas. The heating element may be a clothing iron, heated plate or platen, a heat gun, low-pressure or saturated steam, or water. The heating element may have a temperature of between about 90° C. to about 115° C., such as between about 92° C. to about 108° C. When heating with water having a temperature of between about 92° C. to about 98° C., only between about 3 seconds to about 10 seconds of exposure is needed to sufficiently heat the surface of the PLA bead foam article. By using a heating element, such as a clothing iron, only the desired surface of the molded bead foam article is heated. It has been unexpectedly discovered that two heated surfaces of two molded foam articles formed from PLA may be joined and bonded with a strength comparable to a single molded foam article. Similar bonding has not proven possible with EPS, EPP, or EPE with household appliances such as hair dryer and clothes iron. Instead, hot air welding is necessary to join articles formed from EPP and EPE, which is a process operating at higher temperatures than those achievable with household appliances, necessitating the use of special controls and guards on hot air welding machines. Without intending to be bound by any particular theory, it is believed that PLA-based articles have a glass transition temperature (T_{g}), melting temperature (Tₘ), and degree of crystallinity that is favorable for producing the necessary tackiness upon heating at temperatures achievable with household appliances, steam, or hot water.

It has been unexpectedly discovered that the ability for PLA bead foam articles to adhere to other PLA bead foam articles enables the formation of highly customizable shippers. For example, a shipper that is expected to take longer to arrive and/or to pass through particularly warm climates may be custom-made to have thicker side walls of 3 inches or more, which is not possible with conventional EPS molding techniques, may be custom-made with stand-offs to form air gaps for additional thermal insulation, may include one or more additional PLA bead foam panels to generate thicker side-walls, and may include heat-sealed interfaces to seal the container from thermal energy transfer.

In some embodiments, the molded bead foam article is in the form of a shipper free of labels, tape, adhesive, or a phase-change material. As used herein, a “phase-change material” refers to a material designed to increase, decrease, or maintain the temperature of the interior and contents of a shipper. For example, a pack of ice included in a shipper to prolong the cool or frozen nature of cold contents, such as seafood, is a “phase-change material.” It has been unexpectedly discovered that a container formed exclusively from polylactic acid, when used as a shipper, has improved thermal performance and may be used without any phase-change material. Thus, a shipper as described herein may be loaded with thermally sensitive commodities and sealed with PLA-based film or using a heat seal, and then directly stored in a temperature-controlled warehouse until shipment without the need for phase-change material and without various detrimental effects common in conventional shippers, such as the risk of tape delamination or deterioration of corrugated cardboard. According to the Institute of Packaging Professionals, corrugate is known to deteriorate in compressive strength with time, especially at high relative humidity. After 90 days, corrugate boxes lose 45% of their compressive strength.

In other embodiments, the container is configured to be charged with phase change material, particularly when the container is intended to be used for shipping thermally sensitive contents over long distances, for long periods of time, and/or through particularly warm/cold climates.

In some embodiments, the molded bead foam article is in the form of a fold-flat shipper configured to fold into a container for shipping commodities. As used herein, a “fold-flat shipper” refers to a shipper that may be unfolded into a flat configuration. For example, a shipper in the form of a 6-sided box may be unfolded so that each of the 6 sides are flat, and each of the 6 sides is connected to at least one other side. In some embodiments, the boundary between two sides of a fold-flat shipper are joined to produce a self-standing box. The properties of a box made with fold flat “C”-shaped panels or individual panels is comparable to a molded box with similar dimensions. The fold-flat shipper occupies around 80% less volume during shipment and storage. Thus, fold-flat shippers may be assembled and sealed into a functioning box at either the distributor or the manufacturer.

In some embodiments, the molded bead foam article is in the form of a single panel configured to be inserted into a shipper for improving the thermal and mechanical properties of the shipper. For example, shippers as described herein may be produced in bulk, and those shippers intended to be shipped to warmer climates, or with commodities having a heightened thermal sensitivity, may be supplemented with an additional, stand-alone panel, thereby improving the thermal and mechanical properties of the bulk-produced shipper without the need for unique production lines or processes for those climates or commodities. The panel may be affixed to a base or other article using a hot surface such as a heated platen, hot air, hot water, or steam. Conventional molded foam containers with any single thicker sidewall or base is challenging to produce because of the different molding characteristics associated with varying thicknesses. Thus, simply adding a stand-alone panel enables wall thickness modification without new tooling, enhancing the ability for the container to maintain a desired or suitable temperature.

In some embodiments, the single panel is configured to be affixed to an external surface of the container, such as through the formation of a heat seal or using PLA-based film, as described herein. Such a heat sealed panel may advantageously enhance the thermal properties of the container without affecting the molding process used to form the container, and may further advantageously achieve this enhancement without changing the volume or dimensions of the container cavity.

Methods for Producing Molded Foam Articles

Methods for producing molded foam articles are also disclosed herein. In one aspect, the methods include producing a container as described above. In another aspect, the method includes molding a plurality of foam beads including polylactic acid to produce a molded foam panel, cutting the molded foam panel to produce a plurality of molded foam portions, and forming the container by joining the plurality of portions together. In some embodiments, the method further includes shaping at least one portion in the plurality of portions using one or more of computer numerical control (CNC), lathe machining, or subtractive machining.

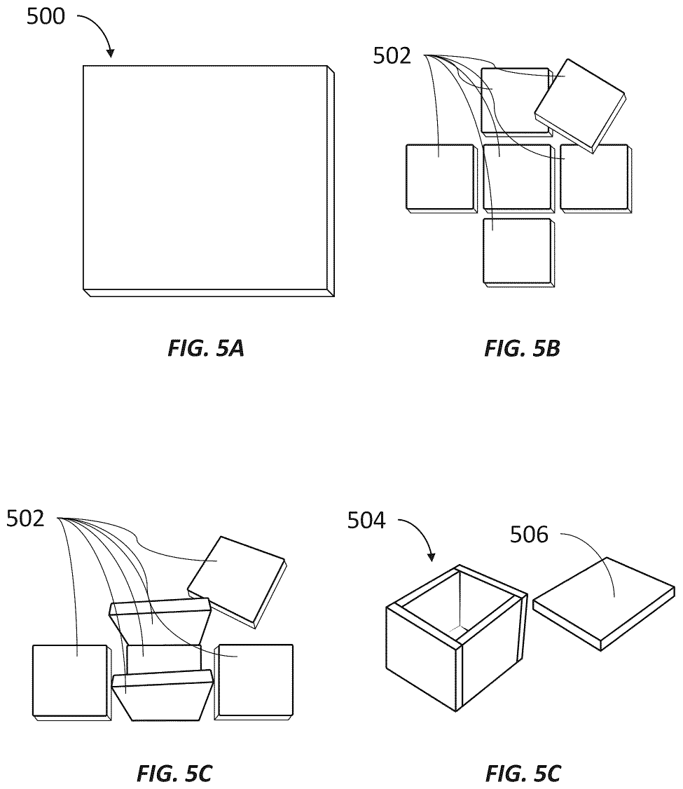

FIGS. 5A-5D depict the steps for forming the container. FIG. 5A depicts a molded foam panel 500. In FIG. 5B, the molded foam panel in FIG. 5A is cut into, for example, six different portions 502. Although six portions are depicted in FIG. 5B, more or fewer portions may be cut from the molded foam panel, and additional unused foam material may remain after cutting out portions. This additional unused material may be used to fabricate another container, or to create foam stand-offs for use in the container as described herein.

FIG. 5C illustrates initial construction of the container from portions 502, with three portions 502 attached together to illustrate the beginning of the container. FIG. 5D depicts a box 504 that is formed from five portions heat-sealed together, with a final portion still separate in the form of a lid 506 for the box. The box 504 is ready to be loaded with phase change material and a payload before heat-sealing the lid 506 to the box 504.

In some embodiments, joining the plurality of portions together includes heat sealing at least one interface between two portions in the plurality of portions. In some embodiments, joining the plurality of portions together includes disposing a polylactic acid-based film on at least one interface between two portions of the plurality of portions.

In some embodiments, cutting the molded foam panel includes cutting the molded foam panel using a knife or wire, such as a heated knife or heated wire.

In some embodiments, the method includes determining an estimated thermal energy duty for a shipment using the container. For example, the thermal energy duty may include (i) estimated travel time, (ii) estimated climate during travel, (iii) desired temperature of contents in the container, or (iv) a combination thereof. Based on the estimated thermal energy duty, the molded foam panel may be cut into a particular number of portions have a particular size, such as a number of larger portions capable of holding both the payload and one or more phase change materials. As another example, the molded foam panel may be cut first into a plurality of portions, and one or more stand-offs may also be cut from the molded foam panel for attaching to the inside of the container, once assembled. As another example, the molded foam panel may be cut into a plurality of portions for a first container, a plurality of stand-offs, and a plurality of portions for a second container.

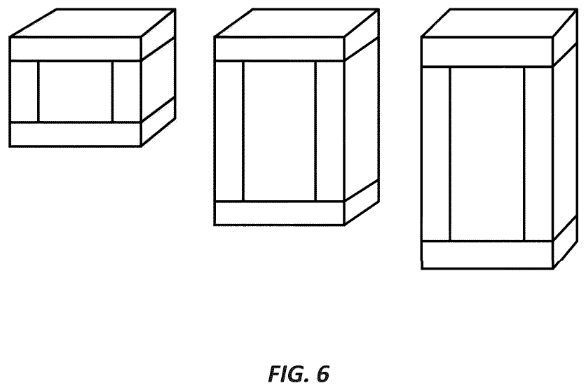

FIG. 6 depicts three containers having different sizes. Depending on the desired thermal energy duty, the container may be formed to a particular size to account for variations in geography or weather, as described above, even for identical payload size or requirements.

In some embodiments, the method includes inserting a payload into the container before finalizing construction of the container. In other words, the container may be constructed around the payload, which may simplify the loading process. For example, a payload having a low clearance between side walls (i.e., a “tighter” fit) may be positioned on top of a first portion, and subsequent portions may be heat-sealed to the first portion around the payload. This is particularly advantageous when human labor is used to load containers; payload can be inserted into the container from the side, rather than from the top, and the “missing side” may be added after loading. This may reduce injuries relating to carrying heavy objects and lowering them into a container opened from only the top.

Therefore, the methods described herein advantageously reduce the costs associated with forming thermal shipping containers in a variety of ways. First, the containers can be formed from a single molded foam panel that is cut and assembled into the container. This molded foam panel may be a standardized panel; one panel size may be produced and can be subsequently formed into a wide variety of container sizes, or combined with another panel to form larger containers or to minimize waste. These panels can also be shipped in a flat configuration, dramatically increasing the number of panels that can be shipped in a given shipment.

Second, forming the container from portions consisting of polylactic acid advantageously enables heat-sealing the various portions together. As a result, there are no gaps through which thermal energy may enter or exit. This can be done by simply heating the surface of the polylactic acid-based portion; such heat sealing is not possible with EPS-based shippers, polyurethane-based shippers, starch-based shippers, paper-based shippers, vacuum insulation panel shippers, or EPP-based shippers. The heat seal that is formed between PLA-based portions unexpectedly has the same thermal and structural properties as a monolithic PLA-based foam article. This superior sealing reduces the need for phase change material, enabling smaller containers.

Third, by forming the container portions from polylactic acid, the portions can be molded to have a thickness of 3 inches or greater, a thickness not possible using typical EPS molding techniques. Instead, oversized EPS foam blocks would need to be formed and machined down to the desired size, which is an incredibly wasteful process. Alternatively, the EPS shipper would need to be supplemented with vacuum insulated panels, polyurethane shippers, or the like, all of which add substantial cost to the overall shipper compared to the PLA-based shippers described herein.

Furthermore, EPS molded bead foam is formed using a pentane blowing agent, which continuously degasses after molding. Large shippers, such as those with an opening of 20 inches or more, are likely to experience a small amount of shrinkage if formed from EPS. This detrimentally affects the seal between, for example, a box and a lid, exacerbating thermal energy loss and spoilage of the contents within the container. In contrast, PLA-based shippers do not experience changes in size of any amount, so the seal formed by heat-sealing is preserved until opened by the consumer.

In some embodiments, the method is performed in-line. In other words, each step of forming the molded foam article is performed subsequently in approximately the same location. In some embodiments, the method is performed by automated apparatus. In other words, apparatus such as robotic instruments may perform each step necessary for forming the molded foam article, such as deliver the foam particles to the mold, mold the molded foam article, remove the molded foam article from the mold, adhere polylactic-based films, heat and join two or more molded foam articles, fold the molded foam article into a shipper, and the like.

### EXAMPLES

The disclosure may be further understood with reference to the following non-limiting examples.

### Example 1: PLA-Based Flat Shipper

A flat shipper formed from polylactic acid was formed as described herein with a portion thickness of 4″ and with internal dimensions of 10″×13″×12″. This shipper was heat-sealed on all sides. The internal cavity was sized to allow packing of a payload with dimensions of 6″×9″×6″: 3×48 oz and 3×16 oz gel packs with combined volume of 192 oz total.

After sealing, the only method of opening the shipper was to use a knife to cut off the top panel. The strength and impact properties of PLA foam restrict opening by just pulling on one of the walls. The external dimensions of the shipper were 18″×21″×20″. The shipper was extremely rugged and was able to withstand the weight of a 200 lb. person standing on top. The container weighed less than 6.5 lbs.

Condensation tests were performed by visually observing any moisture and collecting any moisture. However, no moisture was observed, indicating that the heat-sealed interface was leak proof.

### Example 2: Temperature Testing

The shipper from Example 1 was packed with (3) 48 oz gel packs, (3) 16 oz gel packs, and a 3 lbs payload box that would house (15) vials of medicine. The gel packs had been frozen for a minimum of 72 hours before being placed on a lab bench for at least 15 minutes before starting the pack-out. An infrared thermometer was used to confirm that the surface temperature of the gel packs had reached 2° C. before commencing the pack-out. A temperature monitor was placed within the payload box. This box was kept in a conditioned lab at 22 C for the duration of the test. After 5.5 days, the temperature monitor was retrieved and read 6.3 C. After 7 days, the temperature was 8 C.

As described above, extended duration shippers are challenging to produce from EPS because EPS cannot be molded to ˜3-4 inches thick. The ability to mold thicker PLA-based portions and to be able to join them by simple heat-sealing to produce the shipper enables ground shipment of drugs (i.e., air freight is not necessary because lower temperatures are maintained for longer periods of time). Alternatives to EPS-based shippers such as vacuum insulated panels and molded polyurethane shippers would also provide similar performance, but they suffer from high cost and are often asked to be returned back to the shipper or manufacturer. Furthermore, despite improved performance, vacuum insulated panel shippers have thermal variability from leaks arising from edges and corners where two panels meet. Similarly, polyurethane shippers have variability in density and fit from their manufacturing process. Neither of these solutions can form air-tight seals without additional process steps and cost.

### Example 3: Carbon Footprint Calculation and Cost

The carbon footprint of a shipment by air is multiple times higher than carbon footprint of shipment by ground. To quantify the impact of the container described herein on the ability to reduce the carbon footprint of shipping, two scenarios were compared: shipping a payload in an industry standard EPS box vs. shipping the same payload in a PLA-based shipper of the presented disclosure, with gel packs packed identically in each box, and with each box having the same internal cavity size.

The EPS thermal shipper had outside dimensions 13″×16″×15″ with inner cavity dimensions of 10″×13″×12″ and a wall thickness of 1.5″. This box is placed in a corrugate with dimensions 13.5″×16.5″×15.5″. The EPS foam weighed 2.3 lbs and the corrugate weighed 0.5 lbs. The gel packs and payload weighed 18 lbs. Total weight of the EPS package and payload was 21 lbs. This thermal shipper has an effective thermal energy retention of 40 hours.

The PLA thermal shipper had outside dimensions of 18″×21″×20″ and inner cavity dimensions of 10″×13″×12″. The PLA shipper had a wall thickness of 4″, which is a thickness that cannot be formed using EPS. This box was capable of shipping without using corrugate due to its robustness. The foam weighed 6.5 lbs while gel packs and payload weighed 18 lbs. The total weight of the PLA package was 24.5 lbs. The thermal shipper has an effective thermal energy retention duration of around 144 hours, making it capable of being shipped, for example, across the contiguous United States via ground transportation.

The cost of shipping the EPS shipper via UPS® air and the associated carbon footprint were computed from Lawrence Livermore National Labs in California to Jackson Labs in Maine. UPS® can only deliver by 5 PM the following day, which represents the entire effective thermal energy retention duration of the EPS shipper. The cost of air shipping via FedEx® and UPS® were calculated to be $348 and $306 respectively. The carbon footprint according to ConsumerEcology.com was calculated to be 47 Kg CO2e

The cost of shipping the PLA shipper via UPS® ground shipping cost and carbon footprint were computed; the PLA shipper has a significantly longer effective thermal retention duration, so “ground” shipping was used as the product would arrive in the same condition as the EPS shipper. This shipper was shipped using ground for arrival in 4 to 5 days. Once again, starting point was Lawrence Livermore National Labs and delivery to Jackson Labs in Maine. The cost of ground shipping via FedEx® and UPS® was $129 and $120, respectively. The carbon footprint according to ConsumerEcology.com was calculated to be 8.62 Kg CO2e.

As can be seen, both the cost and carbon footprint of shipping can be reduced by over 60% by using the PLA based shipper described herein despite the larger size and weight.

### Example 4: Thermal Performance of Assembled Shipper Versus Molded Shipper

A comparative thermal duration test was conducted between a thermal shipper assembled from separate panels and a molded counterpart. The test was run in duplicate.

The first sample type was a two-piece commercially available molded EPS thermal shipper with external measurements of 11.1″×9.1″×11.1″ and internal dimensions of 8″×6″×8″. The wall thickness was 1.56 inches. Two of these shippers were obtained.

The second sample type was a shipper made with PLA panels cut with a wire cutter from a larger panel and the pieces joined using heat-sealing. The final dimensions of the PLA-based thermal shipper were 11.1″×9.1″×11.1″ and internal dimension of 8.1″×6.1″×8.1″ with a wall thickness of 1.51 inches. Two of these shippers were assembled.

Each of the four shippers was packed with 2×24 oz gel packs and a 500 ml water bottle to simulate the payload. An internal thermal probe was affixed within each thermal shipper, while an additional probe was immersed within the water bottle to log the temperature of the simulated payload. The evaluation procedure adhered to the ISTA 7E 72-hour summer test protocol. The performance criteria were set to 2-8° C. with the “duration” determined when the bottle temperature reached 8.4° C.

The PLA-based thermal shipper fabricated from assembled panels exhibited impressive endurance, sustaining optimal thermal conditions for approximately 30.8 and 31.1 hours across both boxes. In contrast, the EPS-based molded shippers registered shorter durations of 28.0 and 28.3 hours. This discrepancy in thermal performance is attributed to the superior airtight seal facilitated by the heat-sealed lids of the PLA-based fabricated shippers, which outperformed the interlock mechanism present in the molded counterparts, thereby contributing to an extended duration for the payload.

### Example 5: Use of Plug-Type Lid

Shipping medicine generally requires additional security in the formation of the box to prevent theft or tampering. Thus, the fully heat-sealed box described herein is desirable because the heat-sealed interface operates as a tamper evident seal. However, in other applications where tamper evident seals are not as vital, a removable lid might be preferred. A plug lid enables a tight fit capable of passing shipping studies while allowing the user to reuse the shipper.

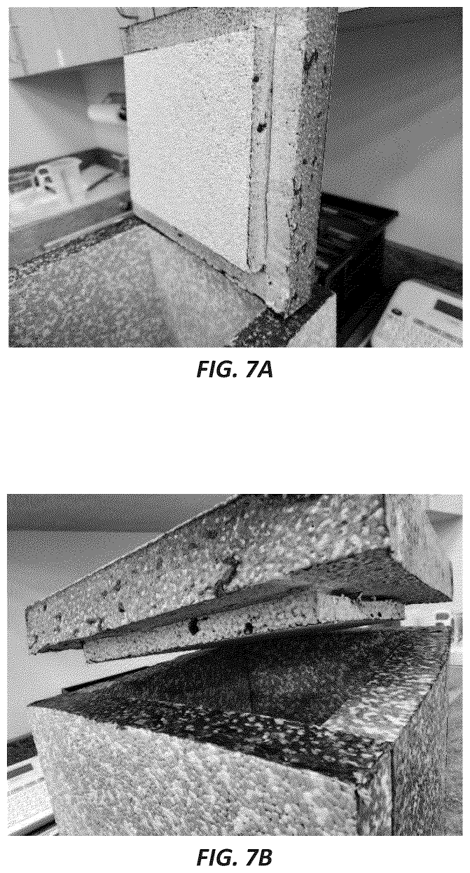

A plug-style lid for a container was created by using two separate thickness panels. The outside panel had a thickness of 2.5″ and a length and width suitable for the outer dimensions of the container. A separate panel matching the internal cavity dimensions of the container was cut from 0.74″ thick panel. The two pieces were heated on a platen to 330 F and joined together using a force around 5 psi. The resulting lid fits well with a separation force between 15-30 lbs. The flat surfaces provide great seal on the two surfaces. The lid is depicted in FIGS. 7A and 7B.

### Example 6: Shipping and Storage Space Savings

The space required to store about 2,160 EPS-based shippers with the 8 most common dimensions are shown in Table 1. Table 1 also shows the space required for the equivalent amount of PLA-based panels necessary to produce these common sizes.

TABLE 1
Space Savings from PLA Use

| | Outside Dimensions (inches) | | | | Molded Shipper | Panels Total | Space |
|---|---|---|---|---|---|---|---|
| Shipper No. | Length | Width | Height | Thickness | Total Volume (cuft) | Volume (cuft) | Savings |
| 1 | 29.0 | 19.0 | 13.5 | 1.5 | 9298 | 2430 | 74% |
| 2 | 20.2 | 15.5 | 15.7 | 1.5 | 6139 | 2100 | 66% |
| 3 | 20.0 | 13.0 | 15.5 | 1.5 | 5040 | 1919 | 62% |
| 4 | 15.1 | 15.1 | 15.1 | 1.5 | 4304 | 1710 | 60% |
| 5 | 19.8 | 15.0 | 13.1 | 2.08 | 4864 | 2374 | 51% |
| 6 | 15.1 | 10.1 | 12.1 | 1.5 | 2307 | 1143 | 50% |
| 7 | 12.1 | 9.1 | 11.1 | 1.5 | 1528 | 882 | 42% |
| 8 | 11.1 | 9.1 | 6.1 | 1.5 | 765 | 461 | 40% |

Thus, the volume saving for shipping and storage between 40% to 74%. Furthermore, the panels may be used to produce different box sizes and thicknesses, including the formation of stand-offs as described herein, representing additional space savings by eliminating the need for many different SKUs of shippers.

### Example 7: Thermal Benefits of Stand-Offs

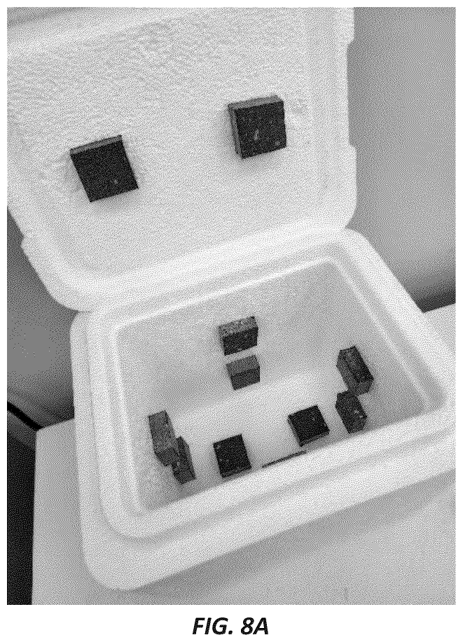

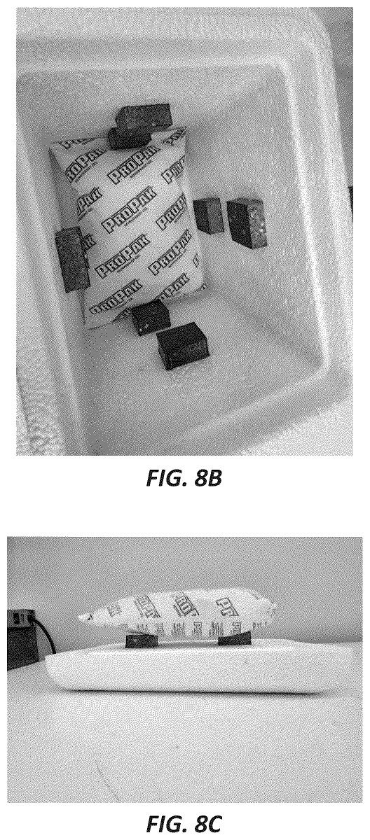

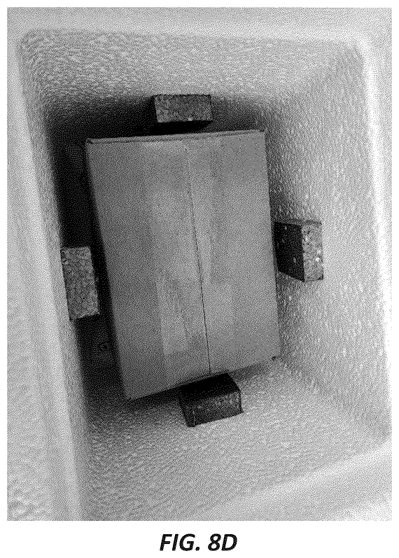

Two boxes were prepared, one with stand-offs and one without. Each box was formed from expanded polylactic acid-based bead foam. Each box shared identical dimensions, with internal dimensions measuring 8″×6″×8″, with a wall thickness of 1.5″. One of the boxes underwent further modification with the addition of 2″×2″×0.75″ stand-offs on each sidewall and the base of the thermal shipper. The box with stand-offs included is depicted in FIG. 8A. Although the box without stand-offs is not depicted, it was identical to the box in FIG. 8A but without stand-offs.

The location of the standoffs were determined using frozen gel packs as guide: these standoffs were placed to create a 0.75″ gap on all sidewalls and the base while preventing gel packs from touching the wall when they thaw. FIGS. 8B and 8C depict the box of FIG. 8A with a gel pack loaded therein.

Both boxes were placed in a conditioned room with a temperature of 72° F. and a humidity level of 40% for a period of 24 hours to condition. Next, conditioning of 24-ounce frozen gel packs and pack-out (i.e., loading of gel packs and payload) was performed using the process outlined in Annex 3 of WHO-IVB-15.3. FIG. 8D depicts the container of FIGS. 8A-8C with a payload placed on top of the gel pack and separated from all container side walls by a gap of air formed by the stand-offs. Deep frozen gel packs which had been frozen for a minimum of 72 hours were removed and placed on a lab bench for at least 15 minutes before starting the pack-out. An infrared thermometer was used to confirm that the surface temperature of the gel packs had reached 2° C. before commencing the pack-out. After sixteen minutes, all gel packs recorded a temperature of 2° C.±0.2° C.

The specific pack-out included three of the conditioned, frozen gel packs in each of the shippers. A lid was securely fastened on both boxes, and both were left in the conditioned lab for the duration of trial.

After 32 hours had elapsed, the lids were momentarily removed from both containers, and an IR reading was taken of the top gel pack from each container. This temperature check was subsequently repeated approximately every 4 hours to determine the time when the top gel pack exceeded a temperature of 8.5° C. This threshold is considered a failure for shipping certain pharmaceuticals.

The results of these temperature measurements are provided below in Table 2. It is worth noting that if the lids had not been removed, each container would have likely maintained lower temperatures for a slightly longer duration, as this would have prevented cold air from escaping.

TABLE 2
Thermal data of shipper equipped with stand-offs

| | Initial | | | | | |
|---|---|---|---|---|---|---|
| Sample | Reading | 32 hours | 36 hours | 41 hours | 46 hours | 50 hours |
| Shipper without | 2° C. | 1.1° C. | 7.9° C. | 8.5° C. | 10.1° C. | 12.5° C. |
| stand-offs | | | | | | |
| Shipper with | 2° C. | 0.9° C. | 4.5° C. | 6° C. | 7.5° C. | 8.6° C. |
| stand-offs | | | | | | |

As shown in Table 1, the time taken to reach the 8.5 C limit could be increased from 41 hours to 50 hours by adding less than 2.1% of foam on the inside wall in the form of stand-offs with no other changes.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A container comprising:
at least two portions configured to be joined together using a heat-seal without the use of adhesive to form the container, each portion consisting of polylactic acid-based molded bead foam.

2. The container of claim 1, further comprising at least one stand-off attached to an inner surface of one of the at least two portions, the stand-off consisting of polylactic acid-based molded bead foam.

3. The container of claim 2, further comprising a foam panel positioned within the container adjacent to the at least one stand-off so that a gap is formed between the panel and the inner surface, wherein the foam panel consists of polylactic acid-based molded bead foam.

4. The container of claim 1, wherein at least one portion has a thickness of 3 inches or greater.

5. The container of claim 1, wherein the heat-sealed interface comprises a tamper-evident seal.

6. The container of claim 2, wherein the at least one stand-off is heat-sealed to the inner surface.

7. The container of claim 2, wherein the at least one stand-off is a molded feature of the inner surface.

8. The container of claim 2, further comprising one or more additional stand-offs each attached to an inner surface of one of the at least two portions, wherein each of the one or more additional stand-offs consist of polylactic acid-based molded bead foam.

9. The container of claim 1, further comprising at least one interface between the at least two portions, wherein the interface is sealed by a PLA-based film.

10. The container of claim 1, wherein the container is configured to be composted without undergoing separation of any component part of the container.

11. The container of claim 2, wherein the container is configured to hold at least one phase change material within the container and in contact with the stand-off so that the at least one phase change material, when present, is separated from the inner surface.

12. The container of claim 1, wherein each side of the plurality of sides includes at least one stand-off, each stand-off consisting of polylactic acid-based molded bead foam.

13. The container of claim 12, further comprising a secondary container disposed within the container and in contact with each of the stand-offs.

14. The container of claim 13, wherein an air gap is formed between the secondary container and the container.

15. The container of claim 1, wherein when a payload is placed within the container, the at least two portions are sized based on a size and thermal demands of the payload.

16. A method for producing a container comprising:
molding a plurality of foam beads consisting of polylactic acid in a mold to produce a molded foam panel,
cutting the molded foam panel to produce a plurality of molded foam portions, and
forming the container by joining the plurality of portions together.

17. The method of claim 16, further comprising shaping at least one portion in the plurality of portions using one or more of computer numerical control, lathe machining, or subtractive machining.

18. The method of claim 16, wherein joining the at least two portions together comprises heat sealing at least one interface between two portions in the plurality of portions.

19. The method of claim 16, wherein joining the plurality of portions together comprises disposing a film comprising polylactic acid on at least one interface between two portions of the plurality of portions.

20. The method of claim 16, wherein cutting the molded foam panel comprises cutting the molded foam panel with a knife or wire.

21. The method of claim 16, further comprising determining an estimated thermal energy duty for a shipment using the container,
wherein cutting the molded foam panel comprises forming portions of a size and shape sufficient to meet the thermal energy duty.

22. The method of claim 21, wherein the thermal energy duty comprises (i) estimated travel time, (ii) estimated climate during travel, (iii) desired temperature of contents in the container, or (iv) a combination thereof.

23. The method of claim 16, wherein the method is performed by automated apparatus.

24. The method of claim 16, further comprising attaching at least one stand-off to an inner surface of one of the portions in the plurality of molded foam portions.

25. The method of claim 16, wherein forming the container comprises:
joining at least two portions together to form a partial container,
inserting a payload into the partial container, and
forming the container by joining one or more portions to the partial container.
